(19) United States
(12) Patent Application Publication
(10) Pub. No.: US 2016/0180184 A1
(43) Pub. Date: Jun. 23, 2016

(54) Far-Field Sensing for Rotation of Finger

(71) Applicant: Apple Inc., Cupertino, CA (US)

(72) Inventors: William M. Vieta, Cupertino, CA (US); Wayne C. Westerman, Cupertino, CA (US)

(21) Appl. No.: 15/056,858

(22) Filed: Feb. 29, 2016

Related U.S. Application Data
(63) Continuation-in-part of application No. 13/843,457, filed on Mar. 15, 2013.
(60) Provisional application No. 61/666,768, filed on Jun. 29, 2012.

(51) Int. Cl. G06K 9/32; G06F 3/01; G06F 1/16; G06K 9/00; G07C 9/00

(52) U.S. Cl. CPC G06K 9/3208; G06K 9/00496; G06K 9/00013; G07C 9/00158; G06F 1/1626; G06F 1/1633; G06F 3/017; G06F 2203/0338

(57) ABSTRACT

An apparatus includes one or more fingerprint image sensors capable of providing fingerprint image information from the finger of a user, and one or more separately disposed orientation sensors, capable of determining one or more orientations of the finger. One or more circuits are coupled to the one or more fingerprint image sensors and the one or more orientation sensors, configured for combining information from the one or more fingerprint image sensors and the one or more fingerprint orientation sensors.

### CROSS-REFERENCE TO RELATED APPLICATIONS

This application is a continuation-in-part of U.S. patent application Ser. No. 13/843,457, filed Mar. 15, 2013, entitled “Far-Field Sensing for Rotation of Finger,” which claims the benefit under 37 C.F.R. §119(e) of U.S. Provisional Application No. 61/666,768, filed Jun. 29, 2012, entitled “Far-Field Sensing for Rotation of Finger,” the contents of both of which are incorporated by reference as if fully disclosed herein.

### TECHNICAL FIELD

This application generally relates to fingerprint imaging and fingerprint sensors.

### BACKGROUND

Fingerprint recognition systems provide for user authentication by collection of fingerprint images and comparing against a database of known fingerprint information. For example, after collecting and processing a set of fingerprint images for an authorized user, accessing users can be authorized by collecting additional fingerprint images, and comparing these additional images against the database.

Collecting fingerprint images, whether from an authorized user, an accessing user, or a new user, typically involves determining the angle at which the user's finger is oriented with respect to the fingerprint sensor. For example, if multiple images are collected at different times, or by different sensors, the relative orientations can be used to compare the different images with those in an authorized user database.

Similarly, when collecting and processing fingerprint images, the angle of a given user's fingerprint may be different from the orientation of the authorized fingerprint images. For example, when the accessing user fingerprint is being compared with a known fingerprint, it may be necessary to adjust the fingerprint image collected from the accessing user, so that it can be more easily compared with fingerprint information from the known authorized user (or with a group of known users).

Orientation of fingerprints can take substantial processing power, whether performed with respect to the fingerprint sensor, or with respect to a known fingerprint database. Finger orientation can also pose difficulties for sensor design, and orientation errors can introduce misalignment, mismatching and processing effects into the fingerprint image data.

Thus, there is a general need for improved fingerprint acquisition and authorization techniques, with greater processing efficiency and alignment capability. There is also a need for fingerprint enrollment and recognition systems that are robust to undesired failure modes exhibited by the prior art, and which provide additional utility and value across a wide range of different electronic devices and other applications.

### SUMMARY

This application is directed to fingerprint imaging and image processing techniques, and electronic devices utilizing these techniques. Depending on application, the devices may utilize one or more fingerprint image sensors configured to provide fingerprint image data from a user. One or more orientation sensors can be disposed separately from the image sensor, and configured for determining an orientation of the use's finger from which the image information is provided.

Typically, one or more electronic circuits can be coupled to the imaging and orientation sensors, and configured for combining sensor information to determine the orientation of the user's finger, for example with respect to the electronic device. A processor can then be configured to generate an oriented fingerprint image, based on the fingerprint image data in combination with the sensed orientation.

Some electronic devices also include touch screen or other display component. In these examples, the orientation sensors can be disposed about the periphery of the display. Alternatively, the orientation sensors may be included in the touch screen

The orientation sensors may include far-field sensors, which are configured to sense the finger orientation at a distance of more than two millimeters, or more. For example, the far-field sensors may include capacitive sensors configured to sense the finger orientation at a distance of more than two centimeters.

In some configurations, the fingerprint sensor may be configured into a control device. A grounding ring may be disposed about the sensor, with gaps or notches configured to determine finger orientation based on differences in grounding strength.

Various processor components can be configured to produce individual oriented image swatches, based on the fingerprint image data and the orientation of the finger. Memory can be provided for storing the individual (e.g., oriented) image swatches, and to combine a plurality of swatches into a unified fingerprint image.

While multiple embodiments are disclosed, including variations thereof, still other embodiments of the present disclosure will become apparent to those skilled in the art from the following detailed description, which shows and describes illustrative embodiments of the disclosure. As will be realized, the disclosure is capable of modifications in various obvious aspects, all without departing from the spirit and scope of the present disclosure. Accordingly, the drawings and detailed description are to be regarded as illustrative in nature and not restrictive.

### BRIEF DESCRIPTION OF THE DRAWINGS

While the specification concludes with claims particularly pointing out and distinctly claiming the subject matter that is regarded as forming the present disclosure, it is believed that the disclosure will be better understood from the following description taken in conjunction with the accompanying Figures, in which:

FIG. 1 shows a conceptual drawing of communication between a touch I/O device and a computing system.

FIG. 2 shows a conceptual drawing of a system including a fingerprint recognition device.

FIG. 3A shows a conceptual drawing of a first example fingerprint sensor and one or more orientation sensors included in a portion of a device, including a first orientation of a user's finger with respect to the touch I/O device.

FIG. 3B shows a conceptual drawing of a first example fingerprint sensor and one or more orientation sensors included in a portion of a device, including a second orientation of a user's finger with respect to the touch I/O device.

FIG. 3C shows a conceptual drawing of a first example fingerprint sensor and one or more orientation sensors included in a portion of a device, including a third orientation of a user's finger with respect to the touch I/O device.

FIG. 4 shows a conceptual drawing of a second example fingerprint sensor and one or more orientation sensors included in a portion of a device.

FIG. 5 shows a conceptual drawing of a fingerprint sensor assisted by one or more orientation sensors while receiving or processing a fingerprint image.

### DETAILED DESCRIPTION

The present disclosure is directed to a fingerprint imaging system or apparatus, electronic devices including the system or apparatus, and methods for their use. The imaging system includes a fingerprint sensor configured to provide fingerprint image data for the finger of a user, and one or more (e.g., separately disposed) orientation sensors configured to determine an orientation of the finger.

Processing and circuits components are configured to combine information from the fingerprint sensor and orientation sensors, in order to determine the orientation of the finger with respect to the fingerprint sensor, and to generate an oriented fingerprint image based on the sensor data. In electronic device applications, the orientation sensors may be disposed about the perimeter of touch screen or other display, and the fingerprint sensor can be provided on or underneath a control button, for example with a separate grounding disposed about the button, in order to provide orientation information based on grounding.

The present disclosure recognizes that personal information data, including biometric data, in the present technology, can be used to the benefit of users. For example, the use of biometric authentication data can be used for convenient access to device features without the use of passwords. In other examples, user biometric data is collected for providing users with feedback about their health or fitness levels. Further, other uses for personal information data, including biometric data, that benefit the user are also contemplated by the present disclosure.

The present disclosure further contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure, including the use of data encryption and security methods that meets or exceeds industry or government standards. For example, personal information from users should be collected for legitimate and reasonable uses of the entity and not shared or sold outside of those legitimate uses. Further, such collection should occur only after receiving the informed consent of the users. Additionally, such entities would take any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices.

Despite the foregoing, the present disclosure also contemplates embodiments in which users selectively block the use of, or access to, personal information data, including biometric data. That is, the present disclosure contemplates that hardware and/or software elements can be provided to prevent or block access to such personal information data. For example, in the case of biometric authentication methods, the present technology can be configured to allow users to optionally bypass biometric authentication steps by providing secure information such as passwords, personal identification numbers (PINS), touch gestures, or other authentication methods, alone or in combination, known to those of skill in the art. In another example, users can select to remove, disable, or restrict access to certain health-related applications collecting users' personal health or fitness data.

Fingerprint Sensor Device and System

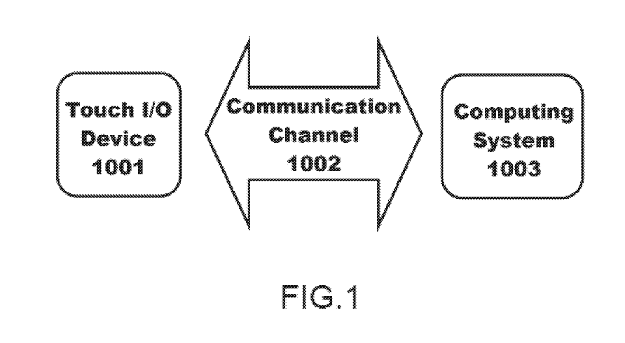

FIG. 1 shows a conceptual drawing of communication between a touch I/O device and a computing system.

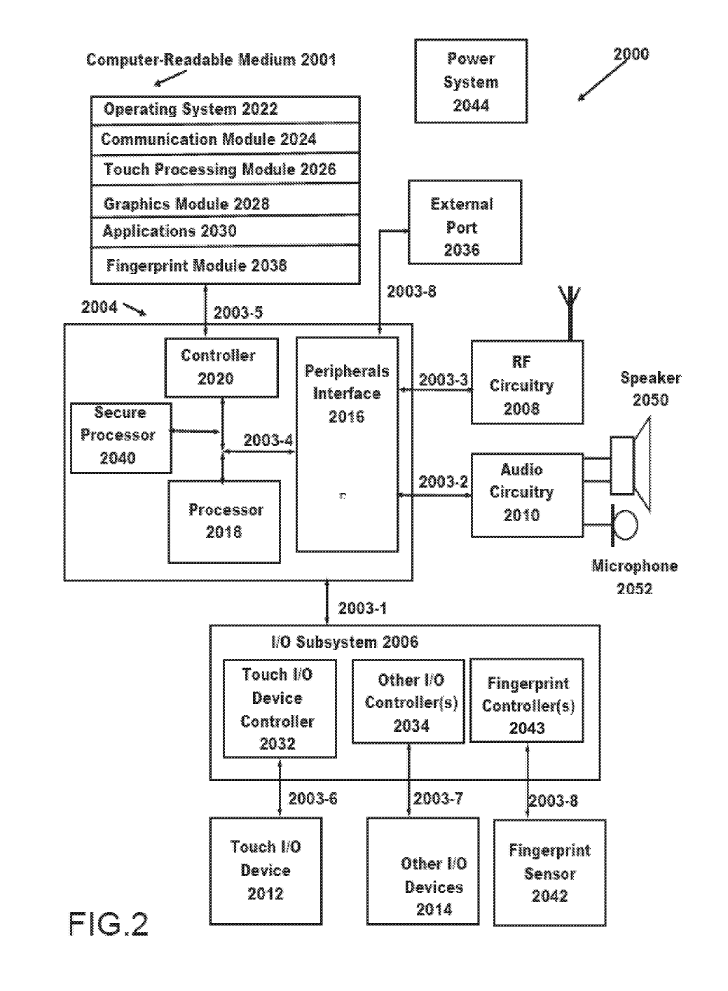

FIG. 2 shows a conceptual drawing of a system including a fingerprint recognition device.

Touch I/O device 1001 can receive touch input for interacting with computing system 1003 via wired or wireless communication channel 1002. Touch I/O device 1001 may be used to provide user input to computing system 1003 in lieu of or in combination with other input devices such as a keyboard, mouse, etc. One or more touch I/O devices 1001 may also be used for providing user input to computing system 1003. Touch I/O device 1001 may be an integral part of computing system 1003 (e.g., touch screen on a laptop) or may be separate from computing system 1003.

For example, touch I/O device 1001 can interact with a user with the user touching the touch I/O device 1001 with the user's finger (or otherwise bringing the user's finger near to the touch I/O device 1001), with the effect that the touch I/O device 1001 can receive fingerprint image data, and optionally provide feedback to the user that the fingerprint image data was received.

Touch I/O device 1001 may include a touch sensitive panel which is wholly or partially transparent, semitransparent, non-transparent, opaque or any combination thereof. Touch I/O device 1001 may be embodied as a touch screen, touch pad, a touch screen functioning as a touch pad (e.g., a touch screen replacing the touchpad of a laptop), a touch screen or touchpad combined or incorporated with any other input device (e.g., a touch screen or touchpad disposed on a keyboard) or any multi-dimensional object having a touch sensitive surface for receiving touch input.

In one example, touch I/O device 1001 embodied as a touch screen may include a transparent and/or semitransparent touch sensitive panel partially or wholly positioned over at least a portion of a display. According to this embodiment, touch I/O device 1001 functions to display graphical data transmitted from computing system 1003 (and/or another source) and also functions to receive user input. In other embodiments, touch I/O device 1001 may be embodied as an integrated touch screen where touch sensitive components/devices are integral with display components/devices. In still other embodiments a touch screen may be used as a supplemental or additional display screen for displaying supplemental or the same graphical data as a primary display and to receive touch input.

Touch I/O device 1001 may be configured to detect the location of one or more touches or near touches on device 1001 based on capacitive, resistive, optical, acoustic, inductive, mechanical, chemical measurements, or any phenomena that can be measured with respect to the occurrences of the one or more touches or near touches in proximity to device 1001. Software, hardware, firmware or any combination thereof may be used to process the measurements of the detected touches to identify and track one or more gestures or fingerprints. A gesture or fingerprint may correspond to stationary or non-stationary, single or multiple, touches or near touches on touch I/O device 1001. A gesture or fingerprint may be performed by moving one or more fingers or other objects in a particular manner on touch I/O device 1001 such as tapping, pressing, rocking, scrubbing, twisting, changing orientation, pressing with varying pressure and the like at essentially the same time, contiguously, or consecutively. A gesture or fingerprint may be characterized by, but is not limited to a pinching, sliding, swiping, rotating, flexing, dragging, or tapping motion between or with any other finger or fingers. A single gesture may be performed with one or more hands, by one or more users, or any combination thereof.

Computing system 1003 may drive a display with graphical data to display a graphical user interface (GUI). The GUI may be configured to receive touch input via touch I/O device 1001. Embodied as a touch screen, touch I/O device 1001 may display the GUI. Alternatively, the GUI may be displayed on a display separate from touch I/O device 1001. The GUI may include graphical elements displayed at particular locations within the interface. Graphical elements may include but are not limited to a variety of displayed virtual input devices including virtual scroll wheels, a virtual keyboard, virtual knobs, virtual buttons, any virtual UI, and the like. A user may perform gestures at one or more particular locations on touch I/O device 1001 which may be associated with the graphical elements of the GUI. In other embodiments, the user may perform gestures at one or more locations that are independent of the locations of graphical elements of the GUI. Gestures performed on touch I/O device 1001 may directly or indirectly manipulate, control, modify, move, actuate, initiate or generally affect graphical elements such as cursors, icons, media files, lists, text, all or portions of images, or the like within the GUI. For instance, in the case of a touch screen, a user may directly interact with a graphical element by performing a gesture over the graphical element on the touch screen. Alternatively, a touch pad generally provides indirect interaction. Gestures may also affect non-displayed GUI elements (e.g., causing user interfaces to appear) or may affect other actions within computing system 1003 (e.g., affect a state or mode of a GUI, application, or operating system). Gestures may or may not be performed on touch I/O device 1001 in conjunction with a displayed cursor. For instance, in the case in which gestures are performed on a touchpad, a cursor (or pointer) may be displayed on a display screen or touch screen and the cursor may be controlled via touch input on the touchpad to interact with graphical objects on the display screen. In other embodiments in which gestures are performed directly on a touch screen, a user may interact directly with objects on the touch screen, with or without a cursor or pointer being displayed on the touch screen.

Feedback may be provided to the user via communication channel 1002 in response to or based on the touch or near touches on touch I/O device 1001. Feedback may be transmitted optically, mechanically, electrically, olfactory, acoustically, or the like or any combination thereof and in a variable or non-variable manner. For example, feedback can include interaction with a user indicating (A) that one or more sets of fingerprint image information have been received, (B) that one or more sets of fingerprint image information have been enrolled in a database, (C) that one or more sets of fingerprint image information have been confirmed as associated with the user, or otherwise.

Attention is now directed towards embodiments of a system architecture that may be embodied within any portable or non-portable device including but not limited to a communication device (e.g. mobile phone, smart phone), a multi-media device (e.g., MP3 player, TV, radio), a portable or handheld computer (e.g., tablet, netbook, laptop), a desktop computer, an All-In-One desktop, a peripheral device, or any other system or device adaptable to the inclusion of system architecture 2000, including combinations of two or more of these types of devices. A block diagram of one embodiment of system 2000 can generally include one or more computer-readable mediums 2001, processing system 2004, Input/Output (I/O) subsystem 2006, radio frequency (RF) or other electromagnetic (EMF) circuitry 2008 and audio circuitry 2010. These components may be coupled by one or more communication buses or signal lines 2003. Each such bus or signal line may be denoted in the form 2003-X, where X is a unique number. The bus or signal line may carry data of the appropriate type between components; each bus or signal line may differ from other buses/lines, but may perform generally similar operations.

It should be apparent that the architecture shown in the figure is only one example architecture of system 2000, and that system 2000 could have more or fewer components than shown, or a different configuration of components. The various components shown in the figure can be implemented in hardware, software, firmware or any combination thereof, including one or more signal processing and/or application specific integrated circuits.

RF circuitry 2008 is used to send and receive information over a wireless link or network to one or more other devices and includes well-known circuitry for performing this function. RF circuitry 2008 and audio circuitry 2010 are coupled to processing system 2004 via peripherals interface 2016. Interface 2016 includes various known components for establishing and maintaining communication between peripherals and processing system 2004. Audio circuitry 2010 is coupled to audio speaker 2050 and microphone 2052 and includes known circuitry for processing voice signals received from interface 2016 to enable a user to communicate in real-time with other users. In some embodiments, audio circuitry 2010 includes a headphone jack (not shown).

Peripherals interface 2016 couples the input and output peripherals of the system to processor 2018 and computer-readable medium 2001. One or more processors 2018 communicate with one or more computer-readable mediums 2001 via controller 2020. Computer-readable medium 2001 can be any device or medium that can store code and/or data for use by one or more processors 2018. Medium 2001 can include a memory hierarchy, including but not limited to cache, main memory and secondary memory. The memory hierarchy can be implemented using any combination of RAM (e.g., SRAM, DRAM, DDRAM), ROM, FLASH, magnetic and/or optical storage devices, such as disk drives, magnetic tape, CDs (compact disks) and DVDs (digital video discs). Medium 2001 may also include a transmission medium for carrying information-bearing signals indicative of computer instructions or data (with or without a carrier wave upon which the signals are modulated, or any other form of signal modulation). For example, the transmission medium may include a communications network, including but not limited to the Internet (also referred to as the World Wide Web), intranet(s), Local Area Networks (LANs), Wide Local Area Networks (WLANs), Storage Area Networks (SANs), Metropolitan Area Networks (MAN) and the like.

One or more processors 2018 can execute, run or interpret various software components stored in medium 2001 to perform various functions for system 2000. In some embodiments, the software components include operating system 2022, communication module (or set of instructions) 2024, touch processing module (or set of instructions) 2026, graphics module (or set of instructions) 2028, one or more applications (or set of instructions) 2030, and fingerprint sensing module (or set of instructions) 2038. Each of these modules and above noted applications correspond to a set of instructions for performing one or more functions described above and the methods described in this application (e.g., the computer-implemented methods and other information processing methods described herein). These modules (i.e., sets of instructions) need not be implemented as separate software programs, procedures or modules, and thus various subsets of these modules may be combined or otherwise rearranged in various embodiments. In some embodiments, medium 2001 may store a subset of the modules and data structures identified above. Furthermore, medium 2001 may store additional modules and data structures not described above.

Operating system 2022 includes various procedures, sets of instructions, software components and/or drivers for controlling and managing general system tasks (e.g., memory management, storage device control, power management, etc.) and facilitates communication between various hardware and software components.

Communication module 2024 facilitates communication with other devices over one or more external ports 2036 or via RF circuitry 2008 and includes various software components for handling data received from RF circuitry 2008 and/or external port 2036.

Graphics module 2028 includes various known software components for rendering, animating and displaying graphical objects on a display surface. In embodiments in which touch I/O device 2012 is a touch sensitive display (e.g., touch screen), graphics module 2028 can include components for rendering, displaying, and animating objects on the touch sensitive display.

One or more applications 2030 can include any applications installed on system 2000, including without limitation, a browser, address book, contact list, email, instant messaging, word processing, keyboard emulation, widgets, JAVA-enabled applications, encryption, digital rights management, voice recognition, voice replication, location determination capability (such as that provided by the global positioning system (GPS) or other positioning systems), a music player, etc.

Touch processing module 2026 includes various software components for performing various tasks associated with touch I/O device 2012 including but not limited to receiving and processing touch input received from I/O device 2012 via touch I/O device controller 2032.

System 2000 may further include fingerprint sensing module 2038 for performing the method/functions as described herein in connection with FIGS. 1-4. Fingerprint sensing module 2038 may at least be executed to, or otherwise function to, perform various tasks associated with the fingerprint sensor, such as receiving and processing fingerprint sensor input. The fingerprint sensing module 2038 may also control certain operational aspects of the fingerprint sensor 2042, such as its capture of fingerprint data and/or transmission of the same to the processor 2018 and/or secure processor 2040. Module 2038 may also interact with the touch I/O device 2012, graphics module 2028 or other graphical display. Module 2038 may be embodied as hardware, software, firmware, or any combination thereof. Although module 2038 is shown to reside within medium 2001, all or portions of module 2038 may be embodied within other components within system 2000 or may be wholly embodied as a separate component within system 2000.

I/O subsystem 2006 is coupled to touch I/O device 2012 and one or more other I/O devices 2014 for controlling or performing various functions. Touch I/O device 2012 communicates with processing system 2004 via touch I/O device controller 2032, which includes various components for processing user touch input (e.g., scanning hardware). One or more other input controllers 2034 receives/sends electrical signals from/to other I/O devices 2014. Other I/O devices 2014 may include physical buttons, dials, slider switches, sticks, keyboards, touch pads, additional display screens, or any combination thereof.

If embodied as a touch screen, touch I/O device 2012 displays visual output to the user in a GUI. The visual output may include text, graphics, video, and any combination thereof. Some or all of the visual output may correspond to user-interface objects. Touch I/O device 2012 forms a touch-sensitive surface that accepts touch input from the user. Touch I/O device 2012 and touch screen controller 2032 (along with any associated modules and/or sets of instructions in medium 2001) detects and tracks touches or near touches (and any movement or release of the touch) on touch I/O device 2012 and converts the detected touch input into interaction with graphical objects, such as one or more user-interface objects. In the case in which device 2012 is embodied as a touch screen, the user can directly interact with graphical objects that are displayed on the touch screen. Alternatively, in the case in which device 2012 is embodied as a touch device other than a touch screen (e.g., a touch pad), the user may indirectly interact with graphical objects that are displayed on a separate display screen embodied as I/O device 2014.

Touch I/O device 2012 may include technologies analogous to the multi-touch surfaces described in the following U.S. Pat. No.: 6,323,846 (Westerman et al.), U.S. Pat. No. 6,570,557 (Westerman et al.), and/or U.S. Pat. No. 6,677,932 (Westerman), and/or U.S. Patent Publication 2002/0015024A1, each of which is hereby incorporated by reference.

In embodiments in which touch I/O device 2012 is a touch screen, the touch screen may use LCD (liquid crystal display) technology, LPD (light emitting polymer display) technology, OLED (organic LED), or OEL (organic electro luminescence), although other display technologies may be used in other embodiments.

Feedback may be provided by touch I/O device 2012 based on the user's touch input as well as a state or states of what is being displayed and/or of the computing system. Feedback may be transmitted optically (e.g., light signal or displayed image), mechanically (e.g., haptic feedback, touch feedback, force feedback, or the like), electrically (e.g., electrical stimulation), olfactory, acoustically (e.g., beep or the like), or the like or any combination thereof and in a variable or non-variable manner.

System 2000 also includes power system 2044 for powering the various hardware components and may include a power management system, one or more power sources, a recharging system, a power failure detection circuit, a power converter or inverter, a power status indicator and any other components typically associated with the generation, management and distribution of power in portable devices.

In some embodiments, peripherals interface 2016, one or more processors 2018, and memory controller 2020 may be implemented on a single chip, such as processing system 2004. In some other embodiments, they may be implemented on separate chips.

In addition to the foregoing, the system 2000 may include a secure processor 2040 in communication with a fingerprint sensor 2042, via a fingerprint I/O controller 2043. Secure processor 2040 may be implemented as one or more processing units. The operation of these various elements will now be described.

The fingerprint sensor 2042 may operate to capacitively capture a series of images, or nodes. When taken together, these nodes may form a set of fingerprint image information. A collection of nodes may be referred to herein as a “mesh”, “mosaic”, “template”, or other indicator of fingerprint information.

Each node of fingerprint information may be separately captured by the fingerprint sensor 2042, which may be an array sensor. Generally, there can be some overlap between images in nodes representing adjacent or nearby portions of a fingerprint. Such overlap may assist in assembling the fingerprint from the nodes, as various image recognition techniques may be employed to use the overlap to properly identify and/or align adjacent nodes in the fingerprint information.

Sensed fingerprint data may be transmitted through the fingerprint I/O controller 2043 to the processor 2018 and/or the secure processor 2040. In some embodiments, the data is relayed from the fingerprint I/O controller 2043 to the secure processor 2040 directly. The fingerprint data is encrypted, obfuscated, or otherwise prevented from being accessed by an unauthorized device or element, by any of the fingerprint sensor 2042, the fingerprint I/O controller 2043 or another element prior to being transmitted to either processor. The secure processor 2040 may decrypt the data to reconstruct the node. In some embodiments, unencrypted data may be transmitted directly to the secure processor 2040 from the fingerprint controller 2043 (or the sensor 2042 if no controller is present). The secure processor may then encrypt this data.

Fingerprint data, either as individual nodes, collections of nodes, or substantially complete fingerprint templates, may be stored in the computer-readable medium 2001 and accessed as necessary. In some embodiments, only the secure processor 2040 may access stored fingerprint data, while in other embodiments either the secure processor or the processor 2018 may access such data.

Fingerprint Sensor Including Orientation Sensors

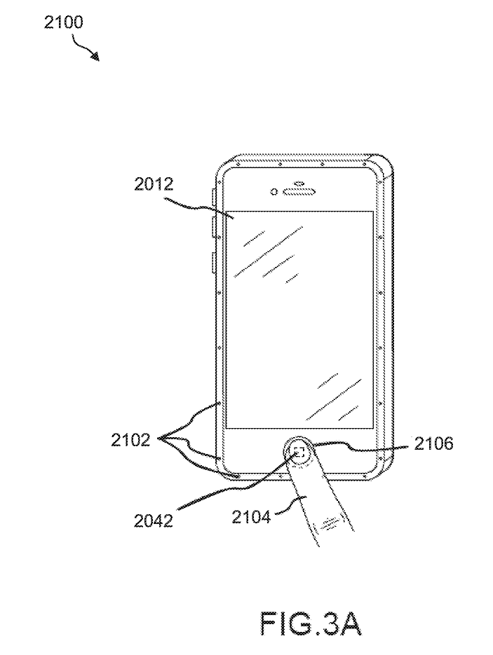

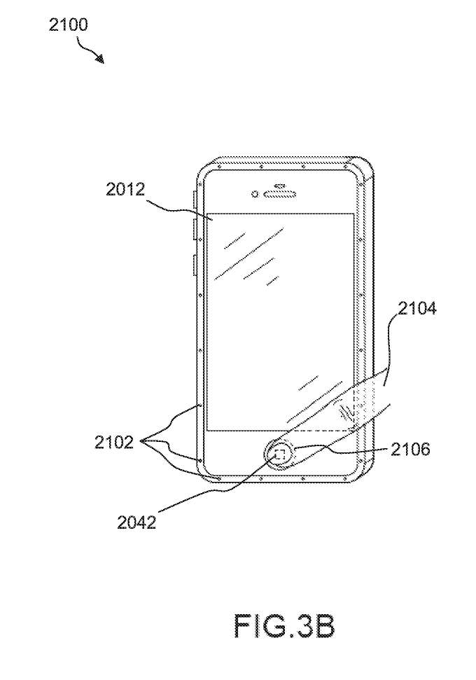

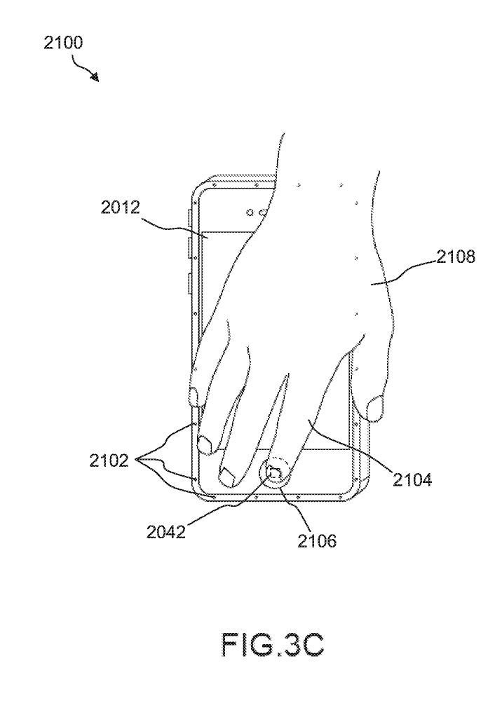

FIG. 3A shows a conceptual drawing of an exemplary fingerprint sensor 2042 and one or more orientation sensors 2102 included in a portion of a device 2100, including a first orientation of a user's finger 2104 with respect to the capacitive touch screen or other touch I/O device 2012.

FIG. 3B shows a conceptual drawing of an exemplary fingerprint sensor 2042 with one or more orientation sensors 2102 included in a portion of a device 2100, including a second orientation of a user's finger 2104 with respect to the touch I/O device 2012.

FIG. 3C shows a conceptual drawing of an exemplary fingerprint sensor 2042 with one or more orientation sensors 2102 included in a portion of a device 2100, including a third orientation of a user's finger 2104 with respect to the touch I/O device 2012.

A device 2100, such as a smart phone or a tablet computer, includes a fingerprint sensor 2042, on or near which the user places their finger 2104, with the effect that the fingerprint sensor 2042 can receive one or more fingerprint images. In one embodiment, the fingerprint sensor 2042 optionally includes the touch I/O device 2012 described herein, and further optionally includes one or more processing units, such as the processor 2018 and the secure processor 2040 described herein. Moreover, the fingerprint sensor 2042 can include, or have access to, memory or storage in which it can maintain and manipulate fingerprint information, such as one or more databases of fingerprint information which can be used to manipulate and compare fingerprint information, as described herein.

In one embodiment, the touch I/O device 2012 includes one or more orientation sensors 2102. The orientation sensors can be disposed in one or more optional locations about the touch I/O device 2012.

For a first example, the one or more orientation sensors 2102 can be disposed about a rim of the device 2100, with the effect of generally surrounding the fingerprint sensor 2042. This has the effect that the one or more orientation sensors can each provide at least some information regarding an orientation of the user's finger 2104 with respect to the fingerprint sensor 2042. For a second example, the one or more orientation sensors 2102 can be disposed in other locations, such as in a pattern on the face of the device 2100, or on the back of the device 2100, or on one or more sides of the device 2100. More generally, the one or more orientation sensors 2102 can include any sensor for proximity which is located outside of the fingerprint sensor device 2042 itself, such as outside a button or touch button 2106, under which the fingerprint sensor 2042 is located.

In one embodiment, the one or more orientation sensors 2102 can provide information with respect to orientation of one or more fingerprint images (or swatches thereof). Depending upon the number of orientation sensors 2102, the search space for the orientation of one or more fingerprint images (or swatches thereof) can be reduced to a limit of plus or minus 20 degrees, approximately. For example, if there are more such orientation sensors 2102, the search space for the orientation of one or more fingerprint images can be reduced to a limit which is relatively lesser, while if there are fewer such orientation sensors 2102, the search space for the orientation of one or more fingerprint images can be reduced to a limit which is relatively larger.

In one embodiment, the one or more orientation sensors 2102 can include capacitive sensors, with the effect that, when the user's finger 2104 is oriented at a first angle with respect to the fingerprint sensor 2042, the capacitive sensors will each provide information regarding a measure of distance of the user's finger 2042 from each such capacitive sensor. For example, the capacitive sensors can include self-capacitive sensors, with the effect of being able to determine whether the user's finger 2042 is hovering above those sensors. This has the effect that a processing unit can determine an angle at which the user's finger 2104 is presented with respect to the fingerprint sensor 2042.

More specifically, the one or more orientation sensors 2102 can include capacitive far-field sensors, with the effect that the one or more orientation sensors 2102 can provide signals with respect to the user's finger 21204 (or fingers 2104, or hand 2108) relatively distantly from signals that might have been provided by the fingerprint sensor 2042 or the touch I/O screen 2012. For example, in some embodiments, the signals provided by the touch I/O screen 2012 would not be effective more than a few millimeters away from the touch I/O screen 2012. Similarly, if the touch I/O screen 2012 is turned off, it would not be providing touch information with respect to the user's fingers.

In one embodiment, this has the effect that the capacitive far-field sensors operate as relatively longer-range capacitive sensors. For example, the capacitive far-field sensors can be disposed about the edge or rim of the device 2100, with the effect that the orientation of the user's finger 2104 can be sensed by one or more capacitive far-field sensors even when the user's finger 2104 is more than several millimeters (and possibly even several centimeters) from the one or more capacitive far-field sensors.

For example, the capacitive far-field sensors can include capacitive hover sensors, with the effect that the orientation sensors 2102 can operate to determine an orientation of the user's finger 2104, whether or not the user's finger 2104 is actually touching those sensors.

More specifically, when the user's finger 2104 is presented at a particular angle with respect to the fingerprint sensor 2042 (such as for example with an axis of the user's finger 2104 at a right angle with respect to an edge of the touch I/O device 2012), the one or more orientation sensors 2102 can each provide information indicating a distance from each particular orientation sensor 2102 to the user's finger 2104. From this information, a processing unit can determine at what angle the axis of the user's finger 2104 is presented with respect to the edge of the touch I/O device 2012. This has the effect that a processing unit can determine a relative orientation of any fingerprint image information received with respect to the user's finger 2104 when the user's finger 2104 is presented in that particular orientation.

For a first example, FIG. 3A shows the user's finger 2104 oriented at an angle close to a right angle with respect to an edge of the touch I/O device 2012. This has the effect that the one or more orientation sensors 2102 disposed near the user's finger 2104 can provide information showing that the user's finger 2104 does not cross any second edge of the touch I/O device 2012, and further, that the one or more orientation sensors 2102 disposed near the user's finger 2104 can provide information showing the approximate angle at which the user's finger 2104 is oriented with respect to the fingerprint sensor 2042.

For a second example, FIG. 3B shows the user's finger 2104 oriented at angle sufficiently distant from a right angle with respect to an edge of touch I/O device 2012, that the user's finger 2104 also crosses a second edge of the touch I/O device 2012. This has the effect that the one or more orientation sensors 2102 disposed near the user's finger 2104 can provide information showing that the user's finger 2104 does indeed cross at least one additional edge of the touch I/O device 2012, and further that the one or more orientation sensors 2102 disposed near the user's finger 2104 can provide information showing the approximate angle at which the user's finger 2104 is oriented with respect to the fingerprint sensor 2042.

For a third example, FIG. 3C shows the user's finger 2104 oriented an angle sufficiently distant from a right angle with respect to an edge of touch I/O device 2012, that both the user's finger 2104 disposed on the fingerprint sensor, and other user's fingers 2104 are also disposed near to one or more orientation sensors 2102. This has the effect that the one or more orientation sensors 2102 disposed near the user's finger 2104 can provide information showing that the user's finger 2104 does indeed cross at least one additional edge of the touch I/O device 2012, and further, that more than one such user's finger 2104 can be sensed by one or more orientation sensors 2102.

In such cases, the one or more orientation sensors 2102 providing information regarding additional user's fingers 2104 can indicate a location and orientation each of those additional user's fingers 2104, with the effect that a processing unit can determine a location and orientation of the user's hand 2108 (with concomitant information about a location and orientation of the user's finger 2104 for which fingerprint image data is being received).

In one embodiment, the orientation sensors 2102 include far-field capacitive sensors, capable of determining distance information with respect to one or more of the user's fingers 2104, such as using capacitive sense technology. In such cases, the orientation sensors 2102 need not have sufficiently accurate sense technology as to obtain sufficient detail to determine fingerprint image data. They need merely have sufficiently accurate sense technology as to determine a measure of distance, and measure orientation, or another measure suitable for similar purposes, with respect to one or more of the user's fingers 2104.

In the context of the invention, there is no particular requirement for any such limitation as described in such embodiments. For example, the orientation sensors 2102 might include optical sensors, infrared sensors, ultrasonic sensors, resistive sensors or other sensors responsive to EMF effects, strain gauges, temperature sensors, or any other type of sensor suitable to achieve the effects described herein with respect to such sensors. Moreover, the orientation sensors 2102 might include capabilities for determining, in lieu of or in addition to distance, a surface angle or other indicator of directionality with respect to one or more of the user's fingers 2104.

For example, in embodiments in which the orientation sensors 2102 include optical sensors or infrared sensors, the orientation sensors 2102 could be used to obtain a picture of the user's finger 2104. Having obtained a picture of the user's finger 2104, the orientation sensors 2102 can use edge detection to determine an orientation of the user's finger 2104.

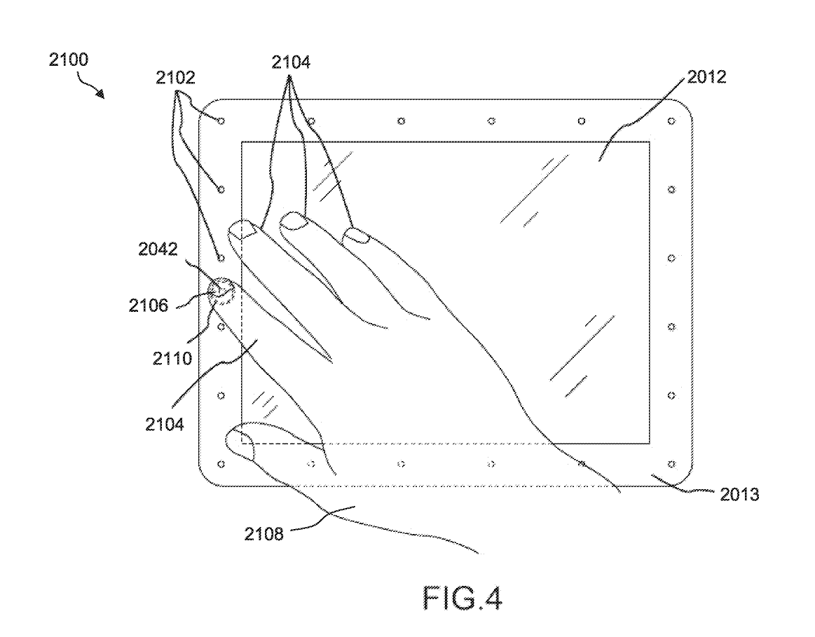

FIG. 4 shows a conceptual drawing of a second example fingerprint sensor 2042 and one or more orientation sensors 2102 included in a frame 2103 or other portion of a device 2100.

In one embodiment, the touch I/O device 2012 includes one or more orientation sensors 2102, and optionally includes a capacitive touch screen as part of the touch I/O device 1001, with the effect that the capacitive touch screen can determine information with respect to one or more of location and orientation information with respect to one or more of the user's fingers 2104. For example, the capacitive touch screen might be capable of determining a proximity of one or more of the user's fingers 2104, from which information can be determined (such as by the processor 2018, the secure processor 2040 or any other processing unit) regarding a location or orientation of the user's hand 2108, and regarding an orientation of the user's finger 2104 from which a fingerprint image is received.

In one embodiment, the touch I/O device 2012 uses a processing unit to receive information from the orientation sensors 2102, and optionally from the capacitive touch screen, from which a processing unit can determine information as described above, from which a processing unit can determine an orientation of the user's finger 2104 from which a fingerprint image is received.

In one embodiment, the touch I/O device 2012 includes a touch button 2106 surrounded by a grounding ring 2110, with the effect that the grounding ring 2110 eliminates extraneous EMF effects other than the capacitive effect between the fingerprint sensor 2042 and the user's fingerprint. In one embodiment, the grounding ring 2110 includes a notched circular ring 2110, such as a relatively circular ring with one or more gaps defined thereby, with the effect that a strongest grounding path can be determined with respect to the relatively circular ring 2110. For example, the touch I/O device 2012 can include a differential amplifier between adjacent notches of the notched circular ring 2110, with the effect that relatively small differences in grounding strength between individual elements of the notched grounding ring 2110 can be determined in response to an orientation of the user's finger 2104.

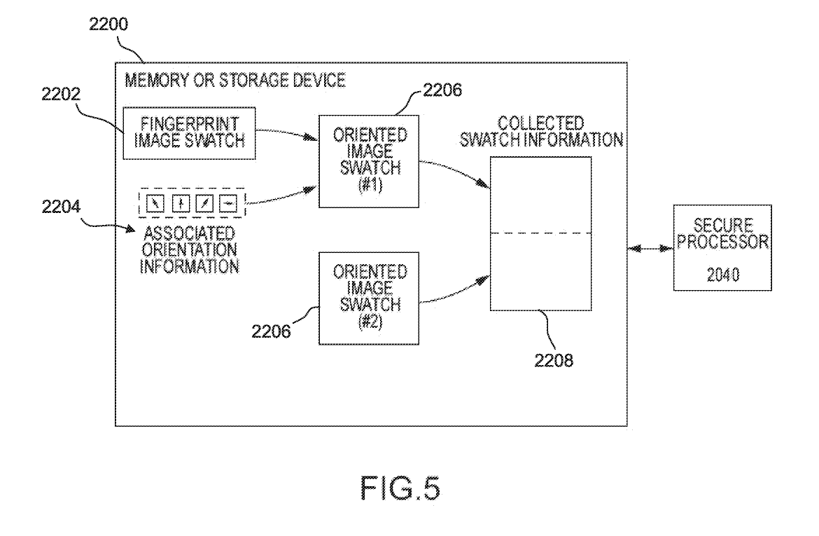

FIG. 5 shows a conceptual drawing of a fingerprint sensor assisted by one or more orientation sensors while receiving or processing a fingerprint image.

In one embodiment, the touch I/O device 2012 includes a secure processor 2040, and includes, or has access to, a memory or storage device 2200, with the effect that the secure processor 2040 can maintain and manipulate fingerprint image data, along with associated orientation information. In alternative embodiments, any processing unit may access the memory or storage device 2200.

In one embodiment, each database of fingerprint information can include a set of fingerprint image data, which can include a set of fingerprint image data, such as may be received from interacting with a fingerprint sensor associated with the touch I/O device 2012 described herein. For example, each set of fingerprint image data be captured by the fingerprint sensor and maintained in memory or storage included with or accessible to a processing unit.

In one embodiment, it is possible that the fingerprint sensor is not large enough to capture an entire fingerprint at once, and can only capture a swatch 2202 of that fingerprint image. For example, it might occur that only one or more individual image swatches 2202 of the user's fingerprint image are captured by the fingerprint sensor, rather than an entire fingerprint image. In one embodiment, whether an entire fingerprint image, or a swatch of a fingerprint image is received, the fingerprint image (or swatch thereof) is associated with orientation information, as the latter is received from one or more orientation sensors. In such cases, receiving orientation information from one or more orientation sensors is intended to include both those orientation sensors which are specifically disposed for obtaining orientation information, and any orientation information which might be gleaned from the capacitive touch screen of the touch I/O device 2012.

In one embodiment, the secure processor 2040 associates the received (or optionally, calculated) orientation information 2204 with the fingerprint image information (or swatch thereof). The secure processor 2040 manipulates the fingerprint image information (or swatch thereof), with the effect of producing an oriented image swatch 2206. The secure processor 2040 can combine a first oriented image swatch 2206 with a second oriented image swatch 2206 to provide a combined data structure of collected swatch information 2208.

In alternative embodiments, the secure processor 2040 can associate the received (or optionally, calculated) orientation information with the fingerprint image information, to provide an oriented fingerprint image. The secure processor 2040 can combine a first oriented fingerprint image with a second oriented fingerprint image to provide a combined data structure representing a unified fingerprint image. For example, in one such case, the secure processor 2040 can combine a first oriented fingerprint image with a second oriented fingerprint image to provide a combined data structure representing a unified fingerprint image, such as a combined fingerprint image including data from both the first oriented fingerprint image and the second oriented fingerprint image. In other embodiments, any processing unit may perform any of the operations discussed above.

### Alternative Embodiments

After reading this application, those skilled in the art would recognize that combining fingerprint image information (or swatches thereof) with associated orientation information is responsive to, and transformative of, real-world data such as fingerprint image data received from a user's fingerprint, and provides a useful and tangible result in the service of enrolling and comparing fingerprints in a biometric security context. Moreover, after reading this application, those skilled in the art would recognize that processing of fingerprint data by a computing device includes substantial computer control and programming, involves substantial records of fingerprint information, and involves interaction with fingerprint sensing hardware and optionally a user interface for fingerprint enrollment and authentication.

Certain aspects of the embodiments described in the present disclosure may be provided as a computer program product, or software, that may include, for example, a computer-readable storage medium or a non-transitory machine-readable medium having stored thereon instructions, which may be used to program a computer system (or other electronic devices) to perform a process according to the present disclosure. A non-transitory machine-readable medium includes any mechanism for storing information in a form (e.g., software, processing application) readable by a machine (e.g., a computer). The non-transitory machine-readable medium may take the form of, but is not limited to, a magnetic storage medium (e.g., floppy diskette, video cassette, and so on); optical storage medium (e.g., CD-ROM); magneto-optical storage medium; read only memory (ROM); random access memory (RAM); erasable programmable memory (e.g., EPROM and EEPROM); flash memory; and so on.

While the present disclosure has been described with reference to various embodiments, it will be understood that these embodiments are illustrative and that the scope of the disclosure is not limited to them. Many variations, modifications, additions, and improvements are possible. More generally, embodiments in accordance with the present disclosure have been described in the context of particular embodiments. Functionality may be separated or combined in procedures differently in various embodiments of the disclosure or described with different terminology. These and other variations, modifications, additions, and improvements may fall within the scope of the disclosure as defined in the claims that follow.

We claim:

1. An apparatus comprising:
one or more fingerprint image sensors configured for providing fingerprint image data from a finger of a user;
one or more orientation sensors disposed separately from the one or more fingerprint image sensors, the one or more orientation sensors configured for determining an orientation of the finger of the user from which the fingerprint image information is provided; and
one or more circuits coupled to the one or more fingerprint image sensors and the one or more orientation sensors, the one or more circuits configured for combining information from the one or more fingerprint image sensors and one or more fingerprint orientation sensors to determine the orientation of the finger of the user.

2. The apparatus of claim 1, further comprising a processor configured generating an oriented fingerprint image for the finger of the user based on the fingerprint image data in combination with the orientation of the finger.

3. An electronic device comprising the apparatus of claim 1 in combination with a touch screen display.

4. The electronic device of claim 3, wherein the one or more orientation sensors are disposed about a periphery of the touch screen display.

5. The electronic device of claim 4, wherein the one or more orientation sensors comprise far-field sensors configured to sense the orientation of the finger at a distance of more than two millimeters therefrom.

6. The electronic device of claim 5, wherein the far-field sensors comprise capacitive sensors configured to sense the orientation of the finger at a distance of more than two centimeters therefrom.

7. The electronic device of claim 3, wherein the touch screen comprises the one or more orientation sensors configured to sense the orientation of the finger at a distance from the touch screen display.

8. The apparatus of claim 1, further comprising a grounding ring disposed about at least one of the one of the one or more fingerprint image sensors, the grounding ring comprising gaps or notches configured for determining differences in grounding strength in response to the orientation of the finger.

9. The apparatus of claim 1, further comprising a processor configured to produce individual oriented image swatches based on the fingerprint image data and the orientation of the finger.

10. The apparatus of claim 9, further comprising memory for storing the individual oriented image swatches, wherein the processor is further configured for combining a plurality of the individual oriented image swatches to provide a unified fingerprint image for the finger of the user.

11. An electronic device comprising:
a display;
a fingerprint image sensor disposed separately with respect to the display, the fingerprint image sensor configured to provide fingerprint image data from a finger of a user of the electronic device;
an orientation sensor disposed separately from the fingerprint image sensor, the orientation sensor configured to provide orientation data for determining an orientation of the finger with respect to the fingerprint image sensor; and
a processor configured to generate an oriented fingerprint image based on the fingerprint image data from the fingerprint image sensor and the orientation data from the orientation sensor.

12. The electronic device of claim 11, wherein the orientation sensor comprises a plurality of far-field sensors disposed about a periphery of the display, the far-field sensors configured to provide the orientation data by sensing the orientation of the finger at a distance therefrom.

13. The electronic device of claim 12, wherein the far-field sensors comprise capacitive sensors configured to provide the orientation data by sensing the orientation of the finger at a distance of more than two millimeters therefrom.

14. The electronic device of claim 11, wherein the orientation sensor comprises a touch-sensitive surface of the display, the touch-sensitive surface of the display configured to provide the orientation data by sensing the orientation of the finger at a distance therefrom.

15. The electronic device of claim 11, further comprising a control button disposed with respect to the display, the control button comprising the fingerprint image sensor therein.

16. The electronic device of claim 15, further comprising a grounding ring disposed about the control button, the grounding ring comprising a plurality of gaps or notches configured for determining differences in grounding strength in response to the orientation of the finger.

17. The electronic device of claim 11, wherein the processor is configured for generating the oriented fingerprint image by combining a plurality of individual fingerprint swatches captured by the fingerprint image sensor, each of the individual fingerprint swatches associated with orientation information received from the orientation sensor.

18. A method for generating oriented fingerprint images in an electronic device having a display, the method comprising:
sensing fingerprint image data with a fingerprint sensor disposed on the device separately from the display, the fingerprint image data characterizing a fingerprint of a finger of a user of the electronic device;
sensing orientation data for the finger with a far-field orientation sensor disposed on the device separately from the fingerprint sensor, the far-field orientation sensor configured to generate the orientation data for the finger at a distance therefrom; and
generating an oriented fingerprint image based on the fingerprint image data from the fingerprint sensor and the orientation data from the far-field orientation sensor.

19. The method of claim 18, wherein sensing the orientation data comprises generating the orientation data with a plurality of far-field capacitive sensors disposed about the display, the plurality of far-field capacitive sensors configured to generate the orientation data for the finger at a distance of more than two millimeters therefrom.

20. A machine readable data storage medium having program data stored thereon, the program data executable by a processor on the device of claim 18 to execute the method thereof.
